(19) United States
(12) Patent Application Publication
(10) Pub. No.: US 2009/0313904 A1
(43) Pub. Date: Dec. 24, 2009

(54) MECHANICAL ACCESS DOOR FOR PASSENGER BUS

(76) Inventors: Andrew Kerr, Winnipeg (CA); Joel Saurette, Winnipeg (CA); Glen Naylor, Winnipeg (CA)

Correspondence Address: OGILVY RENAULT LLP, 1, Place Ville Marie, SUITE 2500, MONTREAL, QC, H3B 1R1, CA

(21) Appl. No.: 12/365,605

(22) Filed: Feb. 4, 2009

(51) Int. Cl. E06B 3/26; B60J 5/10; B60H 1/24

(52) U.S. Cl. 49/503; 49/507; 454/108

(57) ABSTRACT

Mechanical access doors for passenger bus bodies, the doors comprising main panel portions hingedly mounted to mounting edges of body corner openings, and wing panel portions extending generally perpendicular to the main panel portions, wherein the door corners are aligned with the body corner through which the body corner openings extend. Exterior surfaces of the main panels are aligned with exterior surfaces of the bus bodies to which they are attached.

### TECHNICAL FIELD

The invention relates to structures in transit vehicles, and particularly to mechanical access doors for a generally rectangular passenger bus body disposed on a body corner, for example to provide access to an exhaust system or to an air filter system.

### BACKGROUND OF THE ART

The design of passenger buses and other transit vehicles often includes a generally rectangular body structure having two lateral side walls, a roof, a front wall and rear wall joined together at the body corners to define an exterior fairing. The curbside wall of a vehicle such as a bus can include front and rear doors for passenger and driver access to the passenger compartment.

The buses are often rear-wheel drive and the engine is housed in a rear engine compartment. The rear wall of the bus includes large rectangular doors to provide access to the engine and other equipment. Often the rear portion of the side walls also include access doors or ventilation screens to serve the operation and maintenance of the engine.

The invention is directed to mechanical access doors disposed on the corners of the bus body to provide improved access to mechanical equipment such as for example, the engine exhaust system and the engine air intake and air filter system. It will be understood that the invention can also be applied to any corner of the bus body, such as the longitudinal or transverse roof corners, to provide access to air conditioning equipment, lighting, or any other mechanical equipment that is housed within the body or fairing of a passenger bus.

Features that distinguish the present invention from the background art will be apparent from review of the disclosure, drawings and description of the invention presented below.

### DISCLOSURE OF THE INVENTION

In one aspect the invention provides a mechanical access door for a generally rectangular passenger bus body, the body having four side walls and a roof, the four side walls including two lateral side walls, a front wall and a rear wall, the walls merging arcuately together at a plurality of rounded body corners to define an exterior aerodynamic fairing. The body includes a body corner opening comprising a continuous opening in at least a first and a second of said walls at a body corner, the corner opening being open to an internal chamber for housing mechanical equipment. The mechanical access door comprises: a main panel portion hingedly mounted to a mounting edge of the body corner opening, and a wing panel portion extending generally perpendicular to and rigidly mounted along a door corner to said main panel, wherein the door corner is aligned with a body corner through which the body corner opening extends, an exterior surface of the main panel portion is aligned with an exterior surface the first wall through which the body corner opening extends, and an exterior surface of the wing panel portion is aligned with an exterior surface of the second wall through which the body corner opening extends.

In a further aspect, the invention provides, in various embodiments, a mechanical access door for a generally rectangular passenger bus body having four side walls and a roof, the four side walls including two lateral side walls, a front wall and a rear wall, the walls merging arcuately together at a plurality of rounded body corners to define an exterior aerodynamic fairing, the body including a body corner opening comprising a continuous opening in at least two of said walls and the roof at a body corner, the corner opening being open to an internal chamber for housing mechanical equipment. The mechanical access door comprises a main panel portion configured for hinged attachment to a mounting edge of the body corner opening, a wing panel portion extending generally perpendicular to said main panel portion, and an edge portion common to the main panel portion and the wing panel portion. The door is configured, when attached to the mounting edge and closed, to align with a body corner through which the body corner opening extends, an exterior surface of the main panel portion being aligned with an exterior surface of one of the first wall and the roof, an exterior surface of the wing panel portion being aligned with one of the second wall and the roof, and the edge portion of the door being faired to match with the one of the first wall, the second wall, and the roof with which the main panel portion and the wing portion are not aligned.

### DESCRIPTION OF THE DRAWINGS

In order that the invention may be readily understood, sample embodiments are illustrated in the accompanying drawings.

FIG. 1 is a rear-curbside perspective view of a generally rectangular passenger bus body showing mechanical access doors (exhaust system access door 1 and air filter access door 2) on the two rear upper corners.

FIG. 2 is a driverside view showing one vertically hinged mechanical access door 1, 2 (exhaust system access door 1) in an open position.

FIG. 3 is a rear driverside view of the exhaust system access door in an open position.

FIGS. 4 and 8 are rear curbside views of access doors in an open position.

FIG. 5 is an isometric view of a main panel hinge.

FIG. 6 is an isometric view of a mounting bracket for mounting the main panel to the hinge of FIG. 5.

FIG. 7 is sectional view through a hinge and mounting bracket of FIGS. 5-6 showing a square tube structural member of the chassis to which the hinge is fixed to mount the main panel.

Further details of the invention and its advantages will be apparent from the detailed description included below.

### DETAILED DESCRIPTION OF PREFERRED EMBODIMENTS

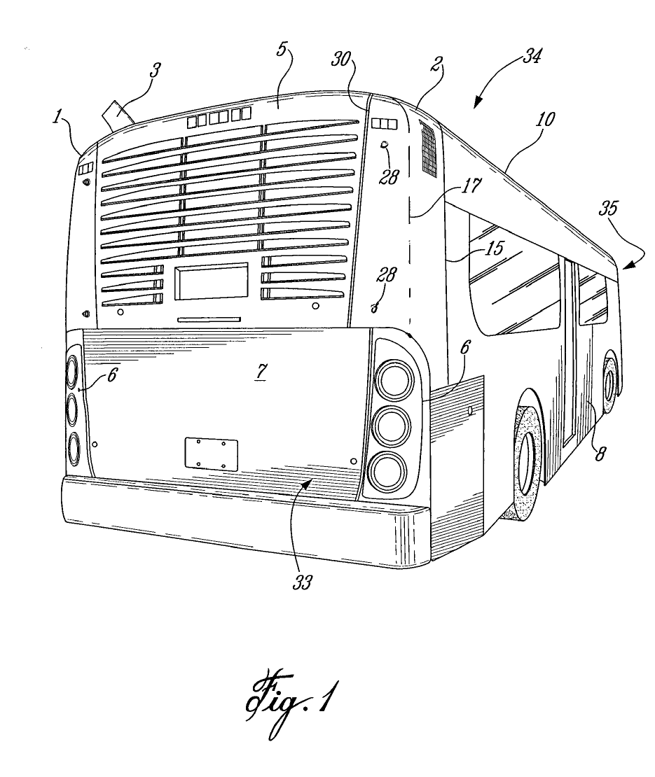

FIG. 1 shows one embodiment of the invention in a rear-curbside perspective view of a generally rectangular passenger bus body showing two vertically hinged mechanical access doors on the two rear upper corners, namely the exhaust system access door 1 and the air filter access door 2. The access doors 1-2 are located at the corners of lateral side walls 8, 9 rear wall 33, and roof 34. Front wall 35 is out of sight at the front end of the bus.

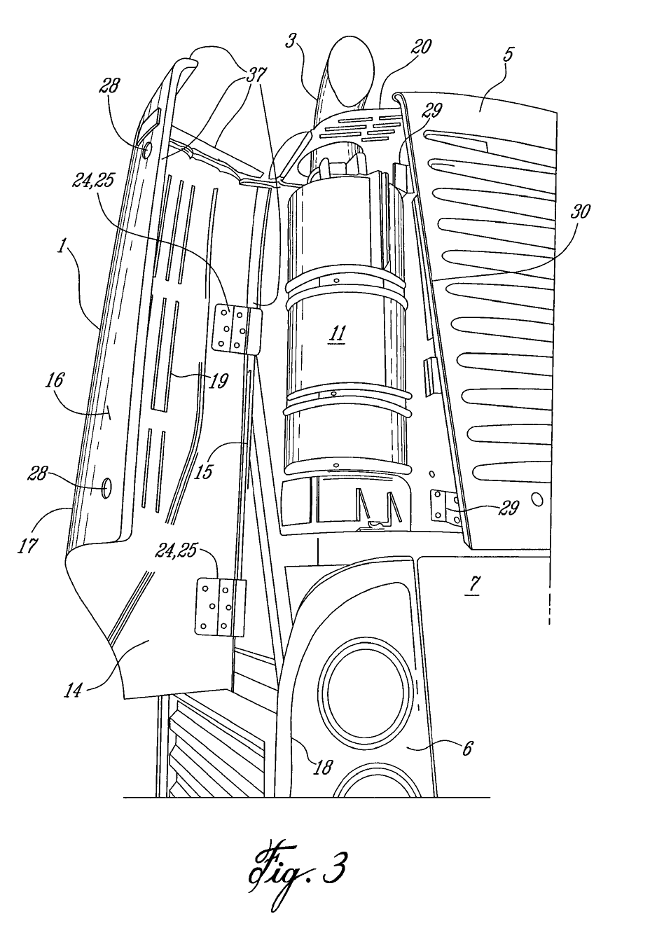

From the top left corner of the bus, an exhaust pipe 3 extends upwardly, with details seen in FIG. 3. The air filter access door 2 includes an air inlet screen 4, with details seen in FIG. 4.

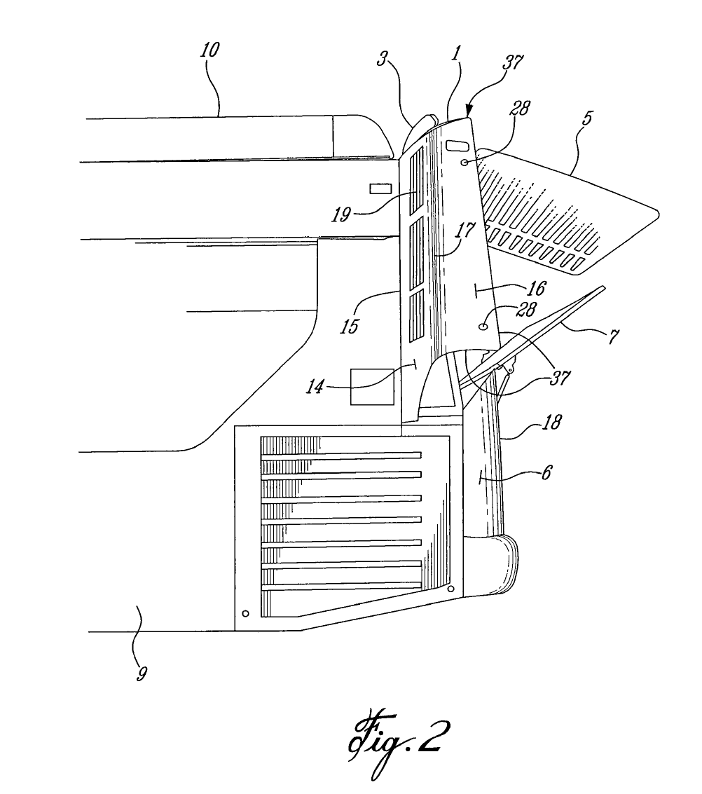

Between the mechanical access doors 1-2, FIG. 1 shows an upper rectangular HVAC or other service access door 5 in a closed position, which is hinged to rotate about a horizontal axis to the open position shown in FIG. 2. Between the corner tail light assemblies 6, a lower rectangular engine access door 7 is shown in the closed position in FIG. 1, and in an open position in FIG. 2.

The generally rectangular passenger bus body shown in FIG. 1 has two lateral side walls (curbside wall 8 in FIG. 1 and driverside wall 9 in FIG. 2), a roof 10, a front wall 35 (not illustrated) and rear wall 33 (including doors 5, 7 and corner tail light assemblies 6) merging arcuately together at a plurality of rounded body corners to define an exterior aerodynamic fairing. Although the drawings illustrate use of mechanical access doors at the rear vertical corners only, it will be understood by those skilled in the art that the invention may be applied to any corner of the bus body such as the longitudinal roof-sidewall corner, the transverse roof-rear wall corner, and the vertical front corners as well.

As seen in FIGS. 3-4, the bus body includes two top rear body corner openings providing a continuous opening at each corner through the rear and side walls at the rear body corners. The corner openings are each open to an internal chamber for housing mechanical equipment. FIG. 3 shows an exhaust system chamber housing a muffler 11. FIG. 4 shows an air intake system chamber housing an air filter 12 and air intake 13.

As seen in FIGS. 3-4, each mechanical access door 1-2 has a main panel portion 14 hingedly mounted to a mounting edge 15 of the associated body corner opening; a wing panel portion 16 extending generally perpendicular to and rigidly mounted along a door corner 17 to the main panel 14; and an edge portion 37 common to the main panel portion 14 and the wing panel portion 16.

The generally vertical door corners 17 are aligned aerodynamically smoothly with the rear body corner 18, partly formed by the corner light assemblies 6 and through which the body corner opening extends. The exterior surface of the main panel portion 14 is aligned with the exterior surface the side wall 8 or 9 through which the body corner opening extends, as seen in FIG. 1 for example to provide a smooth aerodynamic fairing when the doors 1-2 are closed. Likewise the exterior surface of the wing panel portion 16 is aligned with the exterior surface of the rear wall (including doors 5, 7 and corner light assemblies 6) also through which the body corner opening extends. Edge portion 37 is faired to match the respective lateral side walls 8, 9, rear wall 33, and roof 34.

The main panel portion 14 of the exhaust access door 1 includes louver vents 19 which allow cooler air to enter the exhaust system chamber and absorb heat from the muffler 11 which can then be vented through the upper vent 20 surrounding the exhaust pipe 3. The lower louvers 19 may serve as a convection cooling air inlet. The upper louvers 19 and upper vent 20 may serve as a convection cooling air outlet and an engine exhaust leakage outlet from the chamber. Of course the wing panel 16 could also include a vent or louver 19 if necessary, but not illustrated in the embodiment of the drawings. The main panel portion 14 of the air filter access door 2 includes an air inlet screen 4 that serves as an engine air inlet.

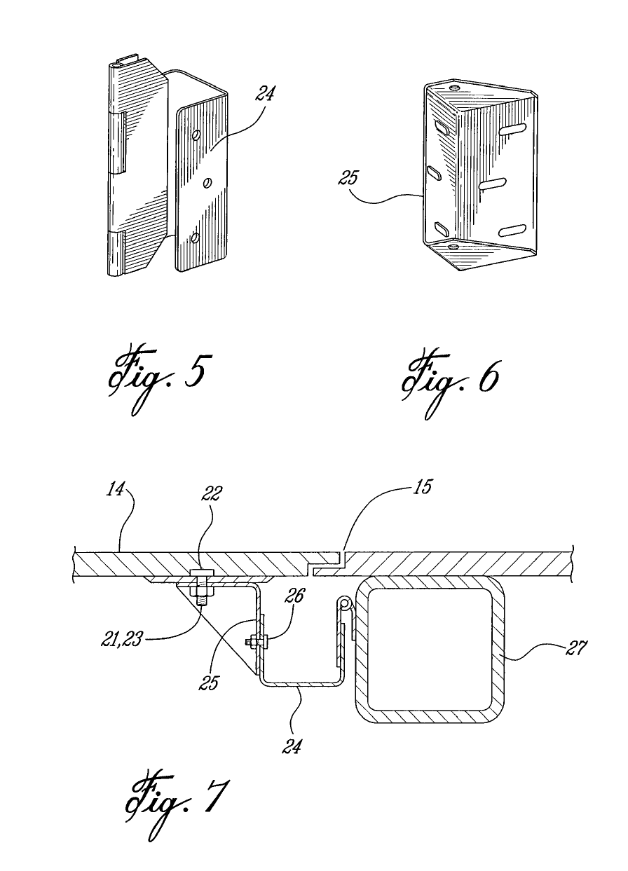

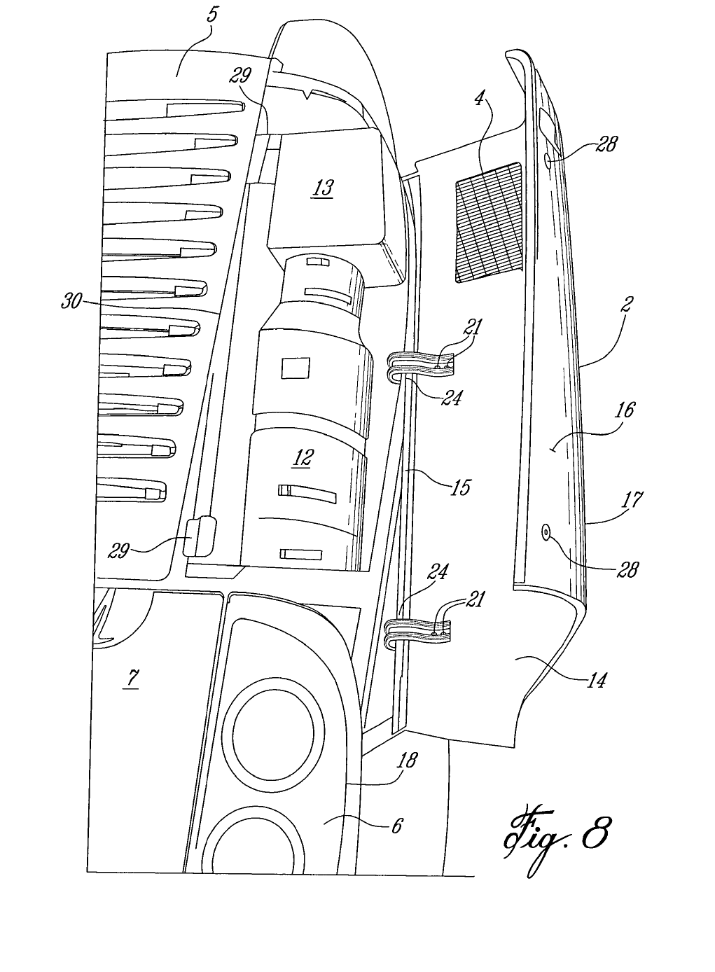

FIGS. 3-8 show details of embodiments of hinges and mounting systems suitable for use in mounting and operating access doors 1-2 according to the invention. To provide for mounting that does not include fasteners or hinge portions visible on the exterior surface of the doors 1-2, particularly when the doors 1-2 are closed, main panel portions 14 can include hinge mounting blind studs 21 each with a stud head 22 and a threaded shaft 23 mounted to project inwardly into the chamber from an inside surface of the main panel 14. The stud heads 22 do not project through an exterior surface of the main panel 14 and are not visible from the exterior. Adhesives or mounting with fiberglass layers are suitable methods of securing the stud heads 22 in position.

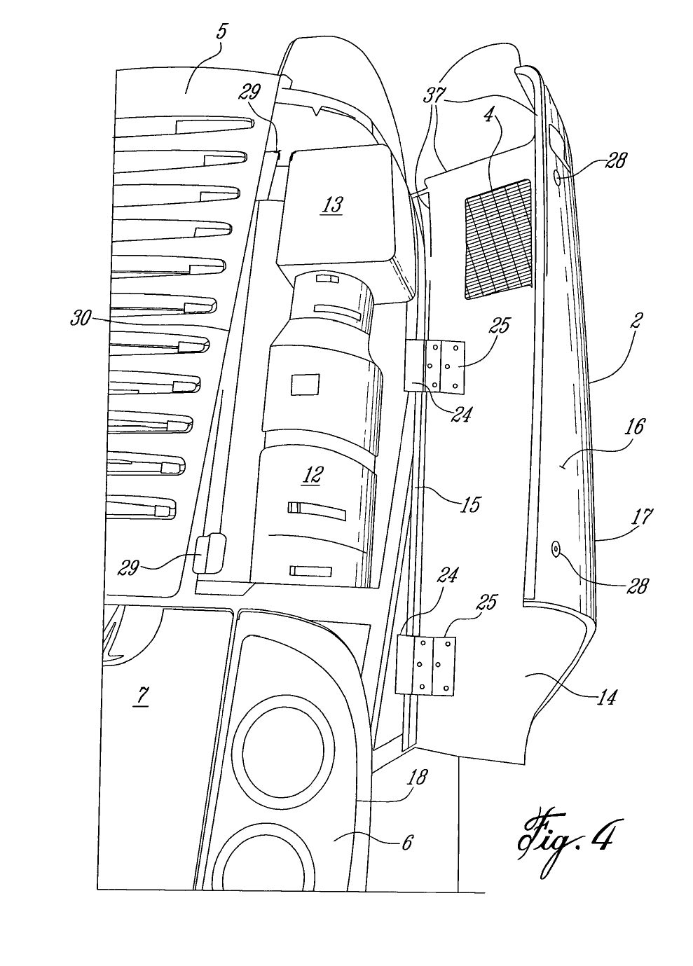

FIG. 5 shows a main panel hinge 24 and a mounting bracket 25 that are used as shown in FIG. 7 to mount the main panel 14 with studs 21 and bolts 26. The main panel 14 is mounted to the main hinge 24 with mounting bracket 26 and the bracket 26 has an outer arm mounted to said stud shafts 23 with threaded nuts. The main hinge 24 has an inner arm adapted for mounting to a bus chassis member 27 inwardly adjacent the mounting edge 15 of the rear corner openings.

As seen in FIGS. 3-4, the wing panel portions 16 can include two rotary latches 28 that are adapted to engage two abutments 29 extending from a securement edge 30 of said body corner opening opposite the mounting edge 15.

Although the above description relates to a specific preferred embodiment as presently contemplated by the inventor, it will be understood that the invention in its broad aspect includes mechanical and functional equivalents of the elements described herein.

I claim:

1. A mechanical access door for a generally rectangular passenger bus body having four side walls and a roof, the four side walls including two lateral side walls, a front wall and a rear wall, the walls merging arcuately together at a plurality of rounded body corners to define an exterior fairing, the body including a body corner opening comprising a continuous opening in at least two of said walls and the roof at a body corner, the corner opening being open to an internal chamber for housing mechanical equipment,
wherein the mechanical access door comprises:
a main panel portion configured for hinged attachment to a mounting edge of the body corner opening,
a wing panel portion extending generally perpendicular to said main panel portion, and
an edge portion common to the main panel portion and the wing panel portion,
wherein the door is configured, when attached to the mounting edge and closed, to align with a body corner through which the body corner opening extends, an exterior surface of the main panel portion being aligned with an exterior surface of one of the first wall and the roof, an exterior surface of the wing panel portion being aligned with one of the second wall and the roof, and the edge portion of the door being faired to match with the one of the first wall, the second wall, and the roof with which the main panel portion and the wing portion are not aligned.

2. A mechanical access door according to claim 1 wherein:
at least one of the main panel portion and the wing panel portion include a vent.

3. A mechanical access door according to claim 2 wherein:
the vent comprises an engine air inlet.

4. A mechanical access door according to claim 2 wherein:
the vent comprises an engine exhaust outlet.

5. A mechanical access door according to claim 2 wherein:
the vent comprises at least one of: a convection cooling air inlet; and a convection cooling air outlet.

6. A mechanical access door according to claim 1 wherein:
the main panel portion includes a plurality of hinge-mounting blind studs each with a stud head and a shaft mounted to project inwardly into said chamber from an inside surface of the main panel and wherein the stud heads do not project through an exterior surface of the main panel portion.

7. A mechanical access door according to claim 6 wherein:
the main panel portion includes a hinge having an outer arm mounted to said stud shafts and an inner arm adapted for mounting to a bus chassis member inwardly adjacent said mounting edge of the body corner opening.

8. A mechanical access door according to claim 1 wherein:
the wing panel portion includes at least one latch.

9. A mechanical access door according to claim 8 wherein:
the at least one latch is adapted to engage an abutment extending from a securement edge of said body corner opening opposite said mounting edge.

10. A mechanical access door for a generally rectangular passenger bus body, the body having four side walls and a roof, the four side walls including two lateral side walls, a front wall and a rear wall, the walls merging arcuately together at a plurality of rounded body corners to define an exterior fairing, the body including a body corner opening comprising a continuous opening in at least a first and a second of said walls at a body corner, the corner opening being open to an internal chamber for housing mechanical equipment,
wherein the mechanical access door comprises:
a main panel portion hingedly mounted to a mounting edge of the body corner opening, and
a wing panel portion extending generally perpendicular to and rigidly mounted along a door corner to said main panel,
wherein the door corner is aligned with a body corner through which the body corner opening extends, an exterior surface of the main panel portion is aligned with an exterior surface the first wall through which the body corner opening extends, and an exterior surface of the wing panel portion is aligned with an exterior surface of the second wall through which the body corner opening extends.

11. A mechanical access door according to claim 10 wherein:
at least one of the main panel portion and the wing panel portion include a vent.

12. A mechanical access door according to claim 11 wherein:
the vent comprises an engine air inlet.

13. A mechanical access door according to claim 11 wherein:
the vent comprises an engine exhaust outlet.

14. A mechanical access door according to claim 11 wherein:
the vent comprises at least one of: a convection cooling air inlet; and a convection cooling air outlet.

15. A mechanical access door according to claim 10 wherein:
the main panel portion includes a plurality of hinge-mounting blind studs each with a stud head and a shaft mounted to project inwardly into said chamber from an inside surface of the main panel portion and wherein the stud heads do not project through an exterior surface of the main panel portion.

16. A mechanical access door according to claim 15 wherein:
the main panel portion includes a hinge having an outer arm mounted to said stud shafts and an inner arm adapted for mounting to a bus chassis member inwardly adjacent said mounting edge of the body corner opening.

17. A mechanical access door according to claim 10 wherein:
the wing panel includes at least one latch.

18. A mechanical access door according to claim 17 wherein:
the at least one latch is adapted to engage an abutment extending from a securement edge of said body corner opening opposite said mounting edge.
